(19) United States
(12) Patent Application Publication
(10) Pub. No.: US 2025/0358028 A1
(43) Pub. Date: Nov. 20, 2025

(54) METHOD AND APPARATUS FOR POWER LEVEL DETERMINATION BY ANALYZING AN OCCURENCE OF RECEIVED POWER SAMPLE VALUES DURING A TIME INTERVAL

(71) Applicant: Telefonaktiebolaget LM Ericsson (publ), Stockholm (SE)

(72) Inventor: Bengt-Erik OLSSON, Hovås (SE)

(73) Assignee: Telefonaktiebolaget LM Ericsson (publ), Stockholm (SE)

(21) Appl. No.: 18/873,902

(22) PCT Filed: Jun. 16, 2022
(86) PCT No.: PCT/EP2022/066510

§ 371 Date: Dec. 11, 2024

(51) Int. Cl. H04B 17/318; H04B 17/26; H04W 76/10

(52) U.S. Cl. CPC H04B 17/318; H04B 17/26; H04W 76/10

(57) ABSTRACT

A method is disclosed for determining received power for a first signal by a device without time synchronization relative to a transmitter of the first signal. The method comprises acquiring a plurality of power samples received during a measurement time interval. A length of the measurement time interval is configured to comprise at least some power samples of the first signal as well as at least some power samples without the first signal. The method also comprises determining the received power for the first signal based on an estimated power level of the first signal, wherein the estimated power level of the first signal is distinguishable by statistically analyzing an occurrence of power values among the plurality of power samples. In some embodiments, the method may be performed for evaluating radio access nodes during a connection process, and/or for evaluating compliance with power regulations, and/or for evaluating coverage provided by a radio reflector. Corresponding computer program product, apparatus, and device are also disclosed.

### TECHNICAL FIELD

The present disclosure relates generally to the field of transmission and reception of signals. More particularly, it relates to determination of received power for a signal.

### BACKGROUND

In many situations, it is desirable to estimate the signal power. Example scenarios where signal power determination is needed include evaluation of compliance with power regulations (e.g., for wireless communication radio access nodes), evaluation of coverage (e.g., for cellular communication systems), and evaluation of signal strength from different radio access nodes during a user equipment (UE) connection process.

When the device that measures and/or determines the signal power lacks (or has inferior) time synchronization relative a transmitter of the signal, a problem may arise if the signal is not continuously transmitted. This is because the device—due to the lacking/inferior time synchronization—cannot know with precision when measurements should be made for accurately capturing the power of the signal of interest. For example, if the device collects samples for power estimation, the samples may—due to the lacking/inferior time synchronization—comprise some power samples with the signal as well as some power samples without the signal. Using such a collection of samples for power estimation would typically result in an erroneous estimation of the power of the signal.

Therefore, there is a need for approaches that enable determination of power for a signal without time synchronization relative a transmitter of the signal.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

Generally, embodiments may be particularly suitable in the context of signaling compliant with the Third Generation Partnership Project (3GPP) specifications.

A first aspect is a method for determining received power for a first signal without time synchronization relative a transmitter of the first signal. The method comprises acquiring a plurality of power samples received during a measurement time interval, and determining the received power for the first signal based on an estimated power level of the first signal, wherein the estimated power level of the first signal is distinguishable by statistically analyzing an occurrence of power values among the plurality of power samples. A length of the measurement time interval is configured to comprise at least some power samples of the first signal as well as at least some power samples without the first signal.

In some embodiments, statistically analyzing the occurrence of power values among the plurality of power samples comprises—for each of a plurality of power value intervals—determining a number of occurrences of power values in the power value interval among the plurality of power samples, and distinguishing an identified power value interval among the plurality of power value intervals, which has a higher number of occurrences of power values than adjacent power value intervals.

In some embodiments, the identified power value interval has a highest number of occurrences of power values among the plurality of power value intervals.

In some embodiments, the estimated power level of the first signal is comprised in the identified power value interval.

In some embodiments, the method further comprises determining the length of the measurement time interval.

In some embodiments, the length of the measurement time interval is determined dynamically.

In some embodiments, the length of the measurement time interval is determined based on a mobility state of a power sampling device.

In some embodiments, the length of the measurement time interval is determined based on one or more of: the number of occurrences of power values of the identified power value interval, and the number of occurrences of power values of adjacent power value intervals.

In some embodiments, the first signal is a downlink signal and the transmitter of the first signal is a radio access node of a wireless communication system.

In some embodiments, the method further comprises determining a number of estimated power levels that are distinguishable by statistically analyzing the occurrence of power values among the plurality of power samples.

In some embodiments, the power samples without the first signal comprise power samples of a second signal.

In some embodiments, the method further comprises determining a received power for the second signal based on an estimated power level of the second signal, wherein the estimated power level of the second signal is distinguishable by statistically analyzing the occurrence of power values among the plurality of power samples.

In some embodiments, the method further comprises determining a difference between the estimated power levels for the first and second signals.

In some embodiments, the second signal is an uplink signal and a transmitter of the second signal is a user equipment (UE) operating within a wireless communication system.

In some embodiments, the length of the measurement time interval is configured to comprise more than one downlink time interval and at least one uplink time interval.

In some embodiments, the second signal is a downlink signal and a transmitter of the second signal is a radio access node of a wireless communication system.

In some embodiments, the transmitter of the first signal is also the transmitter of the second signal, and the first and second signals apply signaling beams of different width and/or different direction.

In some embodiments, the transmitter of the first signal is different from the transmitter of the second signal.

In some embodiments, the method is performed by a user equipment (UE) for evaluating radio access nodes during a connection process.

In some embodiments, the method is performed by a test equipment for evaluating compliance with power regulations and/or for evaluating coverage provided by a radio reflector.

In some embodiments, the power regulations include power conditions for out-of-band frequencies, and the plurality of power samples is acquired for one or more out-of-band frequencies.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for determination of received power for a first signal without time synchronization relative a transmitter of the first signal. The apparatus comprises controlling circuitry configured to cause acquisition of a plurality of power samples received during a measurement time interval, and determination of the received power for the first signal based on an estimated power level of the first signal, wherein the estimated power level of the first signal is distinguishable by statistical analysis of an occurrence of power values among the plurality of power samples. A length of the measurement time interval is configured to comprise at least some power samples of the first signal as well as at least some power samples without the first signal.

A fourth aspect is a device comprising the apparatus of the third aspect.

In some embodiments, the device is a user equipment (UE).

In some embodiments, the device is a test equipment configured to perform measurements for evaluation of compliance with power regulations, and/or for evaluation of coverage provided by a radio reflector.

In some embodiments, any of the above aspects may additionally have features identical with or corresponding to any of the various features as explained above for any of the other aspects.

An advantage of some embodiments is that approaches are provided for determination of power for a signal without time synchronization relative a transmitter of the signal.

An advantage of some embodiments is that the accuracy of the power determination may be improved compared to other approaches.

An advantage of some embodiments is that signal power can be determined without synchronization between the signal transmitter and the device that performs the power measurements and/or the power determination.

An advantage of some embodiments is that no synchronization is required between the device that performs the power measurements/determination and the transmitter of the signal. For example, when embodiments are applied for evaluation of compliance with power regulations of radio access nodes, no synchronization is required between the test system and the radio access network. One example when this advantage May be particularly beneficial is evaluation of power conditions for out-of-band frequencies, where it is often particularly cumbersome to acquire time synchronization.

An advantage of some embodiments is that no apriori knowledge (or less apriori knowledge than for other approaches) is required regarding parameters relating to the transmitter of the signal. For example, when embodiments are applied for evaluation of compliance with power regulations of radio access nodes, no apriori knowledge is required regarding radio access node parameters (e.g., ratio between, and timing of, downlink—DL—and uplink—UL time intervals for time division duplex—TDD).

An advantage of some embodiments is that respective powers of two or more signals may be determined (e.g., for two or more signals with different power levels). For example, when embodiments are applied for evaluation of downlink transmissions from a radio access node, the power level related to transmission of downlink data may be determined as well as the power level related to broadcast transmissions (e.g., synchronization signal block—SSB—transmissions, which are typically transmitted at a lower power than the downlink data).

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2A is a schematic drawing illustrating an example scenario according to some embodiments;

FIG. 2B is a schematic drawing illustrating an example scenario according to some embodiments;

FIG. 2C is a schematic drawing illustrating an example scenario according to some embodiments;

FIG. 3 is a plot illustrating measurements for an example scenario according to some embodiments;

FIG. 4A is a histogram illustrating an example distribution of power measurements according to some embodiments;

FIG. 4B is a histogram illustrating an example distribution of power measurements according to some embodiments;

FIG. 5 is a plot illustrating measurements for an example scenario according to some embodiments;

FIG. 6 is a plot illustrating measurements for an example scenario according to some embodiments;

FIG. 7 is a schematic block diagram illustrating an example apparatus according to some embodiments; and

FIG. 8 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

As already mentioned, determination of signal power can be cumbersome when the device that measures and/or determines the signal power lacks (or has inferior) time synchronization relative a transmitter of the signal; especially if the signal is not continuously transmitted.

To that end, embodiments will be presented herein that enable signal power determination without time synchronization relative a transmitter of the signal.

Some scenarios where embodiments may be particularly useful include evaluation of compliance with power regulations (e.g., for wireless communication radio access nodes), evaluation of coverage (e.g., for cellular communication systems), and evaluation of signal strength from different radio access nodes during a user equipment (UE) connection process.

It should be noted, however, that embodiments may be equally applicable in other scenarios where signal power determination involves a device without time synchronization relative a transmitter of the signal.

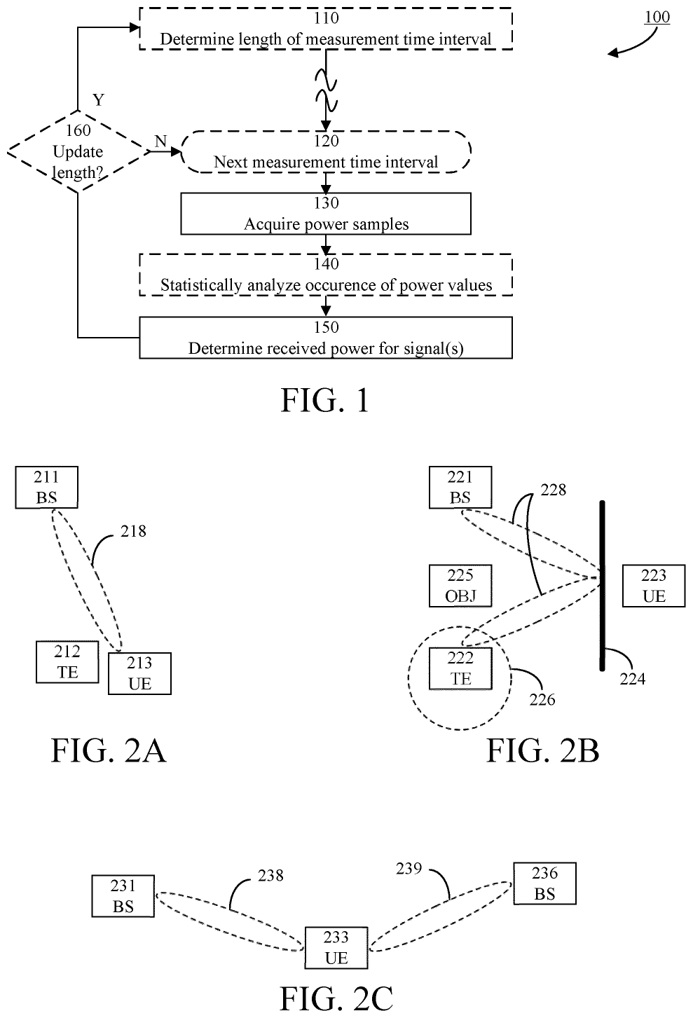

FIG. 1 illustrates an example method 100 according to some embodiments. The method 100 is for determining received power for a first signal without time synchronization relative a transmitter of the first signal. Thus, the method 100 may be used to determine received power for a first signal when there is no time synchronization relative a transmitter of the first signal, or when the time synchronization relative a transmitter of the first signal is inferior. It should be noted that the method 100 may also be used to determine received power for a first signal when there is adequate time synchronization relative a transmitter of the first signal.

As illustrated by step 130, the method 100 comprises acquiring a plurality of power samples. The power samples are received during a measurement time interval, wherein a length of the measurement time interval is configured to comprise at least some power samples of the first signal as well as at least some power samples without the first signal.

Step 130 may comprise performing measurements to acquire the power samples (e.g., by a receiver comprised in the device performing the method 100, in which case the device may be seen as a power sampling device). Alternatively, step 130 may comprise acquiring the power samples in another way (e.g., receiving the power samples from a power sampling device which is not comprised in the device performing the method 100, obtaining previously recorded power samples from a storage, etc.).

The method 100 also comprises determining the received power for the first signal based on an estimated power level of the first signal, as illustrated by step 150. The estimated power level of the first signal is distinguishable by statistically analyzing (140) an occurrence of power values among the plurality of power samples.

In some embodiments, the method 100 also comprises statistically analyzing the occurrence of power values among the plurality of power samples (e.g., by an analyzer comprised in the device performing the method 100), as illustrated by optional step 140. Alternatively or additionally, statistical analysis of the occurrence of power values among the plurality of power samples may be performed by an analyzing device which is not comprised in the device performing the method 100, and the result of the analysis may be indicated to the device performing the method 100.

In some embodiments, steps 130, 140, and 150 are repeated for several measurement time intervals as illustrated by 120 and loop-back from step 150. Generally, the measurement time intervals may be directly subsequent to each other (i.e., the end of one measurement time interval coincides with the start of the next measurement time interval), or there may be a time duration between the end of one measurement time interval and the start of the next measurement time interval.

When there is no, or inferior, time synchronization it is not possible to know which of the power samples are power samples of the first signal and which of the power samples are power samples without the first signal. However, statistical analysis of the occurrence of power values among the plurality of power samples enables determination of the received power for the first signal without such knowledge.

In some embodiments, statistically analyzing the occurrence of power values among the plurality of power samples may comprise (for each of a plurality of power value intervals) determining a number of occurrences of power values in the power value interval among the plurality of power samples, and distinguishing the estimated power level of the first signal from the respective numbers of occurrences in the power value intervals.

Generally, each power value interval may comprise any suitable range of power values. Typically—but not necessarily—the range of power values has the same size for all of the power value intervals, no power value interval overlaps another power value interval, and each power value interval is directly adjacent to at least one (typically two) other power value intervals.

Typically, the estimated power level of the first signal is comprised in the identified power value interval. For example, the estimated power level may be a power level in the middle of the identified power value interval, or may be one of the end points of the identified power value interval.

In some embodiments, distinguishing the estimated power level of the first signal comprises distinguishing an identified power value interval among the plurality of power value intervals, which has a higher number of occurrences of power values than adjacent power value intervals. Thus, the estimated power level of the first signal may be distinguished by finding a local maximum of occurrences of power values.

For example, when the first signal is known to be most frequent in the measurement time interval (e.g., occupying more than half of the measurement time interval, and/or being more frequent than any other signal—with a different power level—potentially present in the measurement time interval) distinguishing the estimated power level of the first signal may comprise distinguishing an identified power value interval among the plurality of power value intervals, which has a highest number of occurrences of power values among the plurality of power value intervals. Thus, the estimated power level of the first signal may be distinguished by finding a global maximum of occurrences of power values.

Determining the received power for the first signal based on the estimated power level of the first signal may be accomplished in any suitable way. For example, the received power for the first signal may be determined as equal to the estimated power level of the first signal for a measurement time interval, as equal to an average estimated power level of the first signal over two or more measurement time intervals, as equal to a median of the estimated power level of the first signal for a plurality of measurement time intervals, or as equal to the result of filtering the estimated power level of the first signal for a plurality of measurement time intervals.

Generally, the length of the measurement time interval may be fixed or dynamically variable. When dynamically variable, the length of the measurement time interval may be initially set to a default value.

In some embodiments, the method 100 comprises determining the length of the measurement time interval, as illustrated by optional step 110. Step 110 may be performed once, or several times, during execution of the method 100. When step 110 is performed several times during execution of the method 100, it may be performed in preparation for each measurement time interval, or more seldom.

The latter is illustrated by optional step 160, which may be in the loop-back from step 150. In step 160, it is determined whether or not the length is to be updated. When the length is to be updated (Y-path out of step 160) the method proceeds to step 110 for determination of the length of the measurement time interval before proceeding to 120. When the length is not to be updated (N-path out of step 160) the method proceeds directly to 120.

When the length of the measurement time interval is dynamically variable, the length may depend on one or more of: a mobility state of a power sampling device, the number of occurrences of power values of the identified power value interval, and the number of occurrences of power values of adjacent power value intervals. The mobility state of the power sampling device may be determined in any suitable manner (e.g., using the mobility state of a UE, or by derivation from positioning data).

For example, the length of the measurement time interval may be short when the mobility state indicates that the power sampling device is rapidly changing location and/or orientation, and the length of the measurement time interval may be long when the mobility state indicates that the power sampling device is static, or only slowly changing location and/or orientation.

Alternatively or additionally, the length of the measurement time interval may be varied when a local or global maximum is/becomes too wide to find a more adequate length. If the width is large due to varying conditions (e.g., mobility and/or other channel variations) a shorter length of the measurement time interval may result in a width decrease. If the width is large due to weak statistical basis (e.g., too few samples) a longer length of the measurement time interval may result in a width decrease.

Generally, a short measurement time interval may be beneficial for tracking rapid changes in the received power since it entails fast updates of the estimated power level, while a long measurement time interval may be beneficial for providing accurate and/or reliable power level estimations in stable conditions since more samples are used to improve statistical certainty.

The measurement time interval may, generally, have any suitable length. An example range for the measurement time interval is 1-10 ms according to some embodiments.

The Y-path out of step 160 may be taken periodically, and/or when a triggering event is met. One example triggering event is that a change occurs in the mobility state of the power sampling device. One example triggering event is that a peak number of occurrences (i.e., the value of a local or global maximum) is below a threshold value and/or decreasing. One example triggering event is that a difference between a peak number of occurrences and that number of occurrences in adjacent power value intervals is below a threshold value and/or decreasing (i.e., the width of a local or global maximum is above a threshold value and/or increasing).

In some embodiments, the power samples without the first signal does not comprise any other signal either (e.g., the power samples without the first signal may comprise only noise). Alternatively, the power samples without the first signal may comprise power samples of one or more other signals (i.e., at least a second signal). Generally, there may, or may not, be time synchronization relative the transmitter(s) of the one or more other signals.

Even though the method 100 has been described for a situation where the received power is determined for a first signal, it should be noted that the method 100 is applicable also for determining respective received powers for several (first, second, etc.) signals; at least when the signals have different received powers. For example, this may be accomplished in a similar manner as already described for the first signal, except that several identified power value intervals are distinguished (i.e., several maxima of occurrences of power values are found)—one per signal.

Alternatively or additionally, the method 100 may comprise determining how many distinct maxima of occurrences of power values are found, and thereby determining a likely amount of signals that are present in the plurality of samples.

Yet alternatively or additionally, the method 100 may comprise determining a difference between the estimated power levels for two (e.g., first and second) signals. For example, the difference between estimated power levels for two signals may be indicative of the beamforming used for the two signals (e.g., wide beam corresponding to relatively low power level and narrow beam corresponding to relatively high power level). Alternatively or additionally, the difference between estimated power levels for two signals may be indicative of particulars of the transmitter of at least one of the signals (e.g., when the first signal is a downlink data signal and the second signal is an uplink signal or a broadcast signal, the difference may indicate a manufacturer of the radio access node and/or an applied communication generation—3G, 4G, 5G, etc.)

Typically, the first signal is a downlink signal and the transmitter of the first signal is a radio access node of a wireless communication system.

In some embodiments, the first signal is a downlink signal transmitted by a radio access node of a wireless communication system and there may, or may not, be a second signal which is an uplink signal transmitted by a user equipment (UE) operating within a wireless communication system. This is particularly relevant for wireless communication systems applying time division duplex (TDD) and scenarios where a test equipment performs the method 100 for evaluating compliance with power regulations and/or for evaluating coverage provided by a radio reflector.

Since no time synchronization is required, the test equipment can be operated completely independently of the operator providing communication through the wireless communication system. For example, the test equipment is not required to have a subscription (e.g., a subscriber identity module, SIM) or to perform any communication with the radio access node to be able to perform the method 100 for evaluating compliance with power regulations and/or for evaluating coverage provided by a radio reflector.

Often, downlink transmissions are allocated more time than uplink transmissions, so the estimated power level of the first signal typically corresponds to a global maximum of occurrences of power values.

Although it may not be known which of the power samples are power samples of the first signal and which of the power samples are power samples without the first signal, the length of one downlink time interval (e.g., a DL slot) and/or the length of one uplink time interval (e.g., an UL slot) may be known. Possibly, it may also be known how many consecutive downlink time intervals and/or how many consecutive uplink time intervals are allowed, and/or the ratio between downlink transmission time and uplink transmission time. Using such knowledge, the length of the measurement time interval may be configured to comprise more than one downlink time interval and at least one uplink time interval, for example. Such a length of the measurement time interval is possible to use since the statistical analysis filters out the uplink power samples, and the length of the measurement time interval is beneficial since it comprises more downlink power samples than if the length of the measurement time interval was based on a single downlink time interval, thereby enabling more accurate determination of the received power.

Evaluating compliance with power regulations may consider power conditions within a spectrum allocated by a regulator to the operator providing communication through the wireless communication system (in-band frequencies) and/or power conditions outside of the spectrum allocated to the operator (out-of-band frequencies). Embodiments may be particularly beneficial for the latter case, since it is often particularly cumbersome to acquire time synchronization for out-of-band frequencies.

In some embodiments, the first signal is a downlink signal transmitted by a radio access node of a wireless communication system and there may, or may not, be one or more (second, third, etc.) signals which are also downlink signals transmitted by respective radio access nodes of the wireless communication system. The different downlink signals may be transmitted by the same radio access node but resulting in different received powers (e.g., due to using different beam widths and/or different beam directions) or they may be transmitted by different radio access nodes. This is particularly relevant when a user equipment (UE) performs the method 100 for evaluating radio access nodes during a connection process; before the UE has acquired adequate time synchronization relative the wireless communication system.

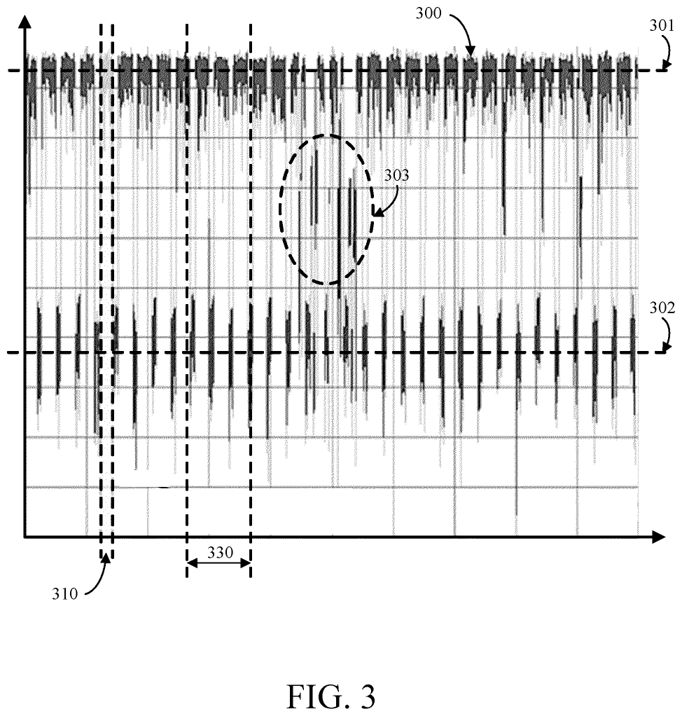

FIGS. 2A, 2B, and 2C schematically illustrates example scenarios where some embodiments may be useful.

In the example scenario of FIG. 2A, a test equipment (TE) 212 is used for evaluating compliance with power regulations by a radio access node. The radio access node is illustrated in the form of a base station (BS) 211, and a user equipment (UE) 213 is utilized to trigger downlink transmissions 218 from the base station 211.

For example, the test equipment 212 may be configured to perform the method 100 of FIG. 1 to determine received power for the downlink transmissions 218 for evaluating compliance with power regulations by the base station 211. Thus, it is not necessary for the test equipment 211 to have time synchronization relative the base station 211 to be able to determine received power for the downlink transmissions 218.

In the example scenario of FIG. 2B, a test equipment (TE) 222 located in an area 226 is used for evaluating coverage provided by a radio reflector 224. The radio reflector 224 is configured to redirect downlink transmissions 228 from a radio access node illustrated in the form of a base station (BS) 221, for coverage of the area 226 (e.g., because a direct radio path from the base station 221 to the area 226 is obstructed by an object (OBJ) 225). In the scenario of FIG. 2B, a user equipment (UE) 223 is utilized to trigger the downlink transmissions 228 from the base station 221.

For example, the test equipment 222 may be configured to perform the method 100 of FIG. 1 to determine received power for the downlink transmissions 228 for evaluating coverage provided by a radio reflector 224 in the area 226. Thus, it is not necessary for the test equipment 221 to have time synchronization relative the base station 221 (or relative the radio reflector 224) to be able to determine received power for the downlink transmissions 228.

In the example scenario of FIG. 2C, a user equipment (UE) 233 is configured to evaluate radio access nodes during a connection process (e.g., to determine which radio access node to connect to). The radio access nodes are represented by two base stations (BS) 231, 236, with respective broadcast transmissions 238, 239. During a connection process, the user equipment 233 may use a random access (RA) procedure to acquire time synchronization. However, some embodiments enable the connection process to be conducted with no, or very coarse, time synchronization relative base stations. Thus, the time synchronization may be performed later than otherwise when some embodiments are applied.

For example, the user equipment 233 may be configured to perform the method 100 of FIG. 1 to determine received power for each of the broadcast transmissions 238, 239 for evaluating the base stations 231, 236 during a connection process. Thus, it is not necessary for the user equipment 231 to have time synchronization relative any of the base stations 231, 236 to be able to determine received power for the broadcast transmissions 238, 239.

Another scenario where some embodiment may be useful is when a user equipment (UE) operating in a wireless communication systems applying TDD is configured to evaluate the power level of a radio access node while being close to an interfering UE. Then, the UE may be configured to perform the method 100 of FIG. 1 to determine received power for transmissions from the radio access node without time synchronization relative the radio access node.

In the following, some exemplification will be provided where power is represented in dBm (a relative representation of power, where the absolute power is compared to a reference power of 1 mW). It should be noted that use of dBm is in no way intended as limiting, and that embodiments are equally applicable regardless of the power representation. For example, an absolute representation or another relative representation may be equally suitable for the power.

FIG. 3 illustrates measurements 300 in the form of power samples as recorded by a test equipment for an example scenario similar to the scenario of FIG. 2A. The x-axis represents time and ranges over a time period of 20 ms. The y-axis represents power and ranges from a received power value of −120 dBm to a received power value of −20 dBm.

From the plot of FIG. 3, it can be seen that there is an approximate power level 301 which corresponds to downlink transmissions, and an approximate power level 302 which corresponds to uplink transmissions. It can also be seen that the downlink transmissions occupy more of the time period than the uplink transmissions. Furthermore, it can be seen that some downlink transmissions (indicated by 303) are associated with a lower received power than the approximate power level 301. For example, such downlink transmissions may result from that a broader beam is used than for the other downlink transmissions.

When it is of interest to determine received power 301 for the downlink transmissions for evaluating compliance with power regulations by a radio access node, one approach may be to use a measurement time interval 310 with a length that corresponds to a downlink time interval, align it as well as possible with a time for downlink transmission, and determine the received power from the power samples in the measurement time interval 310.

A problem with such an approach is that alignment of the measurement time interval 310 with a time for downlink transmission is cumbersome (or even impossible) when the test equipment has no, or inferior, time synchronization relative the radio access node. Thus, there will typically be at least some power samples in the measurement time interval 310 that relate to uplink transmissions rather than downlink transmissions. Therefore, the determination of received power 301 for the downlink transmissions will typically be at least somewhat inaccurate.

Furthermore, even if accurate alignment of the measurement time interval 310 with a time for downlink transmission is accomplished, the number of power samples in the measurement time interval 310 might be too few to provide reliable determination of received power 301 for the downlink transmissions.

Some embodiments address this situation by using a longer measurement time interval 330; with a length that is configured to comprise more than one downlink time interval (and consequently at least one uplink time interval). The received power 301 for the downlink transmissions is determined by statistically analyzing the occurrence of power values among the power samples in the measurement time interval 330 (e.g., as described in connection with FIG. 1).

For example, the occurrence of power values among the power samples may be represented by a number of occurrences in each of a plurality of power value intervals, and the power value interval with highest number of occurrences may be identified. Since the downlink transmissions occupy more of the time period than the uplink transmissions, the power value interval with highest number of occurrences is likely to represent the received power 301 for the downlink transmissions. Thus, a power level associated with the identified power value interval (e.g., a power level in the middle of the identified power value interval) can be used as an estimation of the received power 301 for the downlink transmissions.

Since more downlink samples are used and since the uplink samples are effectively disregarded, the suggested approach related to the measurement time interval 330 typically provides a determination of received power 301 for the downlink transmissions that is more accurate and/or more reliable than if the measurement time interval 310 was used. Furthermore, the determination of received power 301 for the downlink transmissions is not dependent on time synchronization between the test equipment and the radio access node when the suggested approach related to the measurement time interval 330 is used.

Furthermore, some embodiments may be beneficial to distinguish the relatively lower power for downlink transmissions 303.

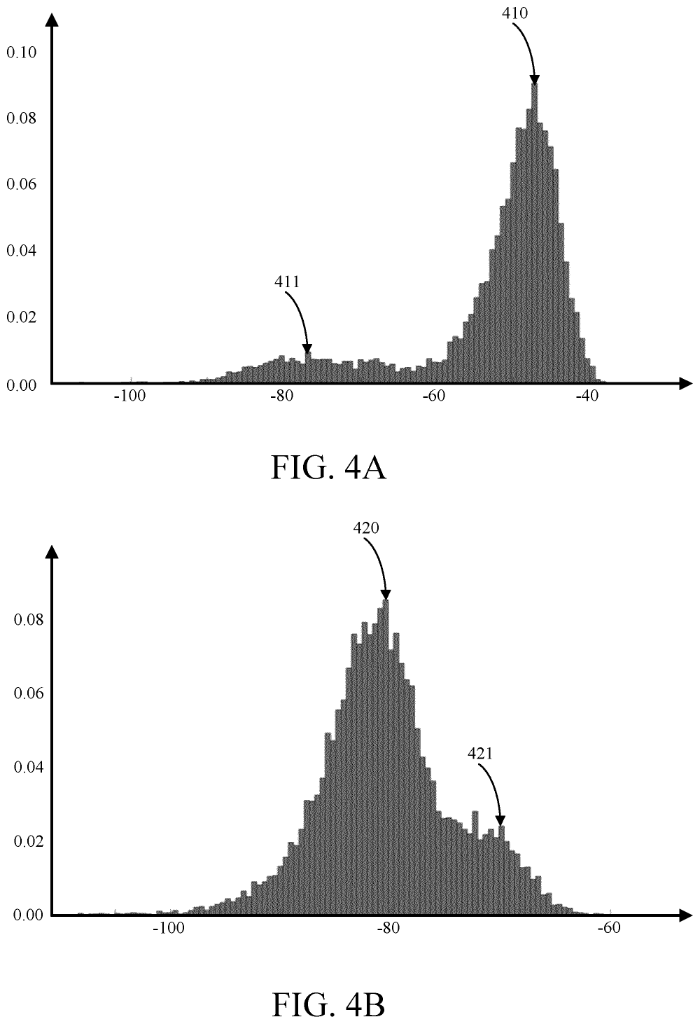

FIGS. 4A and 4B illustrate example distributions of power measurements in the form of histograms. The x-axes represent power values in dBm, and is divided into a plurality of power value intervals. Each bar of the histogram represents the number of occurrences of power values in a particular power value interval. The number of occurrences is represented on the y-axes in the form of a portion of the total number of occurrences (i.e., approximating a probability of occurrence).

The histograms of FIGS. 4A and 4B may be seen as exemplifying illustrations of statistical analysis of the occurrence of power values among a plurality of power samples (compare with step 140 of FIG. 1) to distinguish an estimated power level of a signal.

For example, the histogram in FIG. 4A has a peak (global maximum) 410, and the corresponding power level (approximately −46 dBm) may be considered as the estimated power level of a signal. Similarly, the histogram in FIG. 4B has a peak (global maximum) 420, and the corresponding power level (approximately −81 dBm) may be considered as the estimated power level of a signal.

It may be noted that local maxima (other than the global maximum) may also be distinguished in the histograms of FIGS. 4A and 4B. For example, local maxima 411, 421 may correspond to power levels of another (second) signal.

When the global maxima 410, 420 relate to downlink transmissions, the local maxima 411, 421 may relate to uplink transmissions (compare with the scenario of FIG. 2A and the scenario of FIG. 2B). For example, FIG. 4A may represent a scenario with a relatively strong DL signal 410 and a relatively weak UL signal 411, and FIG. 4B may represent a scenario with a relatively weak DL signal 420 and a relatively strong UL signal 421.

Alternatively, when the global maxima 410, 420 relate to broadcast transmissions from one radio access node, the local maxima 411, 421 may relate to broadcast transmissions from another radio access node (compare with the scenario of FIG. 2C).

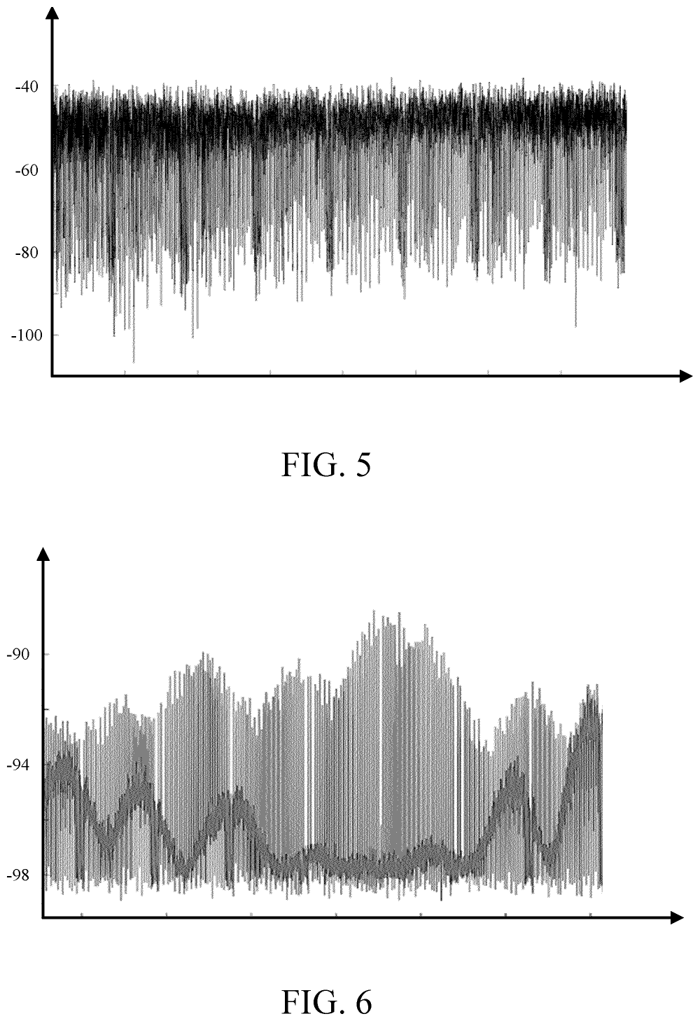

FIGS. 5 and 6 illustrate example power measurements in relation to two different measurement situations. The x-axes represent time and the y-axes represent power in dBm.

When the method 100 of FIG. 1 is repeatedly applied for power measurements of FIG. 5 (i.e., when a sequence of measurement time intervals with different starting times are used for successive estimations of a signal power level to determine the received power for the signal), the estimated signal power level will be approximately equal for the different measurement time intervals.

Hence, a relatively long measurement time interval may be applied and/or the estimated signal power level from relatively many measurement time intervals may be used to determine the received power for the signal (e.g., by averaging, filtering, or similar).

The relatively stable situation reflected in FIG. 5 may, for example, correspond to a scenario where there is no relative movement between the transmitter of the signal and the power sampling device, and there are no rapid variations in the channel conditions (e.g., due to a dominating line-of-sight path between the transmitter of the signal and the power sampling device).

When the method 100 of FIG. 1 is repeatedly applied for power measurements of FIG. 6 (i.e., when a sequence of measurement time intervals with different starting times are used for successive estimations of a signal power level to determine the received power for the signal), the estimated signal power level will vary substantially for the different measurement time intervals. Also, the power samples relating to a signal of interest may vary substantially within a measurement time interval.

Hence, a relatively short measurement time interval may be applied and/or the estimated signal power level from relatively few measurement time intervals (e.g., one) may be used to determine the received power for the signal.

The relatively unstable situation reflected in FIG. 6 may, for example, correspond to a scenario where there is relative movement between the transmitter of the signal and the power sampling device, and/or there are rapid variations in the channel conditions (e.g., due to fast fading).

Some further exemplification of some embodiments will now be provided, wherein focus will be on downlink measurements for 5G new radio (NR) scenarios without time synchronization (e.g., over-the-air, OTA, field testing).

With 5G NR being deployed, there is an increasing need for regulatory authorities in different jurisdictions/countries to monitor compliance with license parameters (e.g., power regulations) among the operators that provide communication. Typically, such regulatory authorities operate locally (e.g., in a country), but also cooperate in multinational organizations such as the European Conference of Postal and Telecommunications Administrations (CEPT) in order to align approaches with each other (e.g., regarding in-field measurement methods for telecom equipment).

For example, methods for in-field measurements of power emissions from 5G base stations are desired to allow monitoring of compliance with license restrictions for the installation. Various parameters may be of interest for monitoring compliance with licensing restrictions (e.g., transmission direction(s), total radiated power (TRP), out-off-band spurious emission, etc.). The monitoring of such parameters often requires that the received power in a particular location is measured with high accuracy, and some embodiments may be suitable for performing such measurements.

In relation to 5G, signaling from the base station is significantly more lean compared to previous generations. For example, very little power is emitted from a 5G base station unless a user equipment (UE) is connected. This makes in-field testing more complicated than before, and the field-testing engineer typically need to bring a UE and have it in connected mode (e.g., download data) during the measurement phase such that a signal suitable for measurements is obtained from the base station (compare with the scenario of FIG. 2A).

Furthermore, 5G base stations typically use beamforming approaches to produce beams of various widths and directions, which is beneficial to focus power to a UE, to reduce interference, etc. This increases the need for the field-testing engineer to bring a UE and have it in connected mode during the measurement phase to have the base station direct a beam towards the UE.

The field-testing engineer typically also brings measurement equipment (a.k.a., test equipment). For example, the test equipment may comprise a receiving antenna connected to signal recording equipment. Thus, a typical approach for collecting power samples may include holding the UE (drawing traffic from the base station) close to the receiving antenna of the test equipment, aligning the receiving antenna of the test equipment towards the base station, and recording the received signal samples (compare with step 130 of FIG. 1).

As already elaborated on, it is beneficial to be able to distinguish between power originating from the base station (i.e., downlink transmissions) and power originating from the UE (i.e., uplink transmissions). For example, the uplink transmissions should be disregarded when monitoring licensing restriction compliance by the base station. Some embodiments may be particularly beneficial to accomplish this.

Another application where it is beneficial to be able to distinguish between power originating from a base station and power originating from a UE is measurements of coverage provided by a radio reflector (compare with the scenario of FIG. 2B). In such applications, a UE may be placed in the vicinity of (e.g., behind, in front of, or beside) the radio reflector. Having the UE in connected mode (e.g., download data) during a measurement phase entails that a signal suitable for measurements is obtained from the base station and redirected towards an area in which the radio reflector should/might provide coverage. Then, test equipment may be applied in the area to evaluate the coverage. Some embodiments may be particularly useful in such scenarios.

As already discussed, a problem is encountered in test situations as those outlined above when the communication system applies TDD, wherein different time intervals (e.g., time slots) are used for downlink and uplink. The problem relates to that the test equipment and/or analyzing equipment evaluating the recorded power samples needs to distinguish between power that is associated with the downlink and power that is associated with the uplink.

This may be accomplished by acquiring time synchronization to align measurement time intervals such that only power that is associated with the downlink is recorded. For example, a clock of the test equipment may be synchronizes to the universal global positioning system (GPS) or to another (e.g., satellite based) time alignment system. Many base stations use GPS for internal synchronization. Therefore, this approach may provide relatively adequate time synchronization. Referring to FIG. 3, the measurements 300 may represent a time domain NR signal with DL and UL time slots and the measurement time interval 310 may represent a time gated DL slot in the test equipment.

Alternatively or additionally, some embodiments may be applied to determine received power associated with the downlink from power samples relating to both downlink and uplink.

For example, time domain samples recorded by the test equipment (compare with FIG. 3) may be statistically analysed to determine the average power level relating to downlink transmission (i.e., excluding power samples relating to uplink transmissions).

In a typical example, the radio frequency (RF) reception of a test equipment is recorded in the form of time domain power samples (e.g., as exemplified in FIG. 3). The recording is divided into time boxes (measurement time intervals), each comprising at least two DL time intervals (and consequently at least one UL time interval). For each of the time boxes, it is possible to identify at least two different power levels by statistically analysing the number of samples within particular ranges of power values. When DL time intervals are longer than UL time intervals (e.g., when DL slots are longer than UL slots as for NR), the range of power values which has the most sample occurrences typically corresponds to the DL power. It should be noted that the received UL power may be higher than the received DL power (e.g., when the UE is very close to the receiver antenna of the test equipment). As already mentioned, the length of the time boxes can be dynamically variable (e.g., to minimize histogram peak width).

Some advantages achieved by application of some embodiments include: that no synchronization is required between the test equipment and the base station, that no apriori knowledge of base station parameters (e.g., TDD DL/UL ratio) is required, and that all DL power can be captured and used for evaluation (e.g., power relating to SSB and/or other signaling events transmitted with relatively low power).

Furthermore, when measurements are made in relation to signals outside the NR carrier band, time synchronization may be even more cumbersome since the time alignment may differ from that used inside the NR carrier band. Application of some embodiments may address this problem by not requiring time synchronization to determine respective received power level for one or more signals.

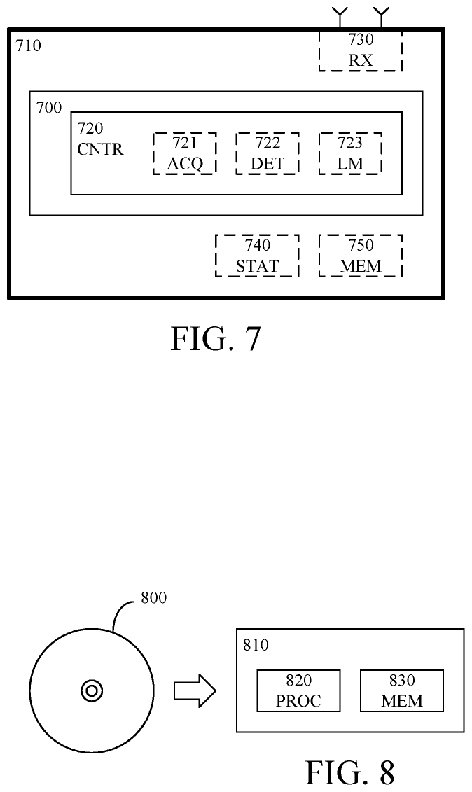

FIG. 7 schematically illustrates an example apparatus 700 according to some embodiments. For example, the apparatus 700 may be configured to perform, or cause performance of, one or more steps as described in connection with the method 100 of FIG. 1. Alternatively or additionally, the apparatus 700 may be comprisable (e.g., comprised) in a device 710 (e.g., a UE or a test equipment).

The apparatus 700 is for determination of received power for a first signal without time synchronization relative a transmitter of the first signal. The apparatus comprises a controller (CNTR; e.g., controlling circuitry or a control module) 720.

The controller 720 is configured to cause acquisition of a plurality of power samples received during a measurement time interval (compare with step 130 of FIG. 1).

To this end, the controller 720 may comprise, or be otherwise associated with (e.g., connected, or connectable, to) an acquirer (ACQ; e.g., acquiring circuitry or an acquisition module) 721. The acquirer 721 may be configured to acquire the plurality of power samples.

For example, the controller 720 may be configured to cause acquisition of the plurality of power samples via a receiver (RX; e.g., receiving circuitry or a reception module) 730 of the device 710, and/or from a memory (MEM; e.g., storing circuitry or a storage module) 750 holding previously recorded power samples. In FIG. 7, the memory 750 is illustrated as comprised in the device 710, while it is also possible that the memory is external to the device 710 (e.g., comprised in another device, or distributed in association with a cloud service).

The controller 720 is also configured to cause determination of the received power for the first signal based on an estimated power level of the first signal (compare with step 150 of FIG. 1).

To this end, the controller 720 may comprise, or be otherwise associated with (e.g., connected, or connectable, to) a determiner (DET; e.g., determining circuitry or a determination module) 722. The determiner 722 may be configured to determine the received power for the first signal based on the estimated power level of the first signal.

The estimated power level of the first signal is distinguishable by statistical analysis of an occurrence of power values among the plurality of power samples. The controller 720 may be configured to cause statistical analysis of the occurrence of power values among the plurality of power samples (compare with step 140 of FIG. 1).

To this end, the controller 720 may comprise, or be otherwise associated with (e.g., connected, or connectable, to) a statistical analyzer (STAT; e.g., analyzing circuitry or an analysis module) 740. The statistical analyzer 740 may be configured to statistically analyze the occurrence of power values among the plurality of power samples. In FIG. 7, the statistical analyzer 740 is illustrated as comprised in the device 710, while it is also possible that the statistical analyzer is external to the device 710 (e.g., comprised in another device, or distributed in association with a cloud service).

A length of the measurement time interval is configured to comprise at least some power samples of the first signal as well as at least some power samples without the first signal. The controller 720 may be configured to cause determination of the length of the measurement time interval (compare with steps 110, 160 of FIG. 1).

To this end, the controller 720 may comprise, or be otherwise associated with (e.g., connected, or connectable, to) a length manager (LM; e.g., managing circuitry or a management module) 723. The length manager 723 may be configured to determine the length of the measurement time interval.

Generally, it should be noted that features and advantages described in connection with one of the Figures herein, when suitable, is equally applicable—mutatis mutandis—for any other one of the Figures; even if not explicitly mentioned in connection thereto.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus or a device, such as a user equipment (UE) or a test equipment.

Embodiments may appear within an electronic apparatus (such as a user equipment (UE) or a test equipment) comprising arrangements, circuitry, and/or logic according to any of the embodiments described herein. Alternatively or additionally, an electronic apparatus (such as a user equipment (UE) or a test equipment) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 8 illustrates an example computer readable medium in the form of a compact disc (CD) ROM 800. The computer readable medium has stored thereon a computer program comprising program instructions. The computer program is loadable into a data processor (PROC; e.g., a data processing unit) 820, which may, for example, be comprised in a user equipment (UE) or a test equipment 810. When loaded into the data processor, the computer program may be stored in a memory (MEM) 830 associated with, or comprised in, the data processor. According to some embodiments, the computer program may, when loaded into, and run by, the data processor, cause execution of method steps according to, for example, the method illustrated in FIG. 1, or method steps otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for determining received power for a first signal without time synchronization relative a transmitter of the first signal, the method comprising:
acquiring a plurality of power samples received during a measurement time interval, wherein a length of the measurement time interval is configured to comprise at least some power samples of the first signal as well as at least some power samples without the first signal; and
determining the received power for the first signal based on an estimated power level of the first signal, wherein
the estimated power level of the first signal is distinguishable by statistically analyzing an occurrence of power values among the plurality of power samples.

2. The method of claim 1, wherein statistically analyzing the occurrence of power values among the plurality of power samples comprises:
for each of a plurality of power value intervals, determining a number of occurrences of power values in the power value interval among the plurality of power samples; and
distinguishing an identified power value interval among the plurality of power value intervals, which has a higher number of occurrences of power values than adjacent power value intervals.

3. The method of claim 2, wherein the identified power value interval has a highest number of occurrences of power values among the plurality of power value intervals.

4. The method of claim 2, wherein the estimated power level of the first signal is comprised in the identified power value interval.

5. The method of claim 1, further comprising determining the length of the measurement time interval.

6. (canceled)

7. The method of claim 5, wherein the length of the measurement time interval is determined based on a mobility state of a power sampling device.

8. The method of claim 5, wherein the length of the measurement time interval is determined based on one or more of: the number of occurrences of power values of the identified power value interval, and the number of occurrences of power values of adjacent power value intervals.

9. The method of claim 1, wherein the first signal is a downlink signal and the transmitter of the first signal is a radio access node of a wireless communication system.

10. The method of claim 1, further comprising determining a number of estimated power levels that are distinguishable by statistically analyzing the occurrence of power values among the plurality of power samples.

11. The method of claim 1, wherein the power samples without the first signal comprise power samples of a second signal.

12. The method of claim 11, further comprising determining a received power for the second signal based on an estimated power level of the second signal, wherein the estimated power level of the second signal is distinguishable by statistically analyzing the occurrence of power values among the plurality of power samples.

13. The method of claim 11, further comprising determining a difference between the estimated power levels for the first and second signals.

14. The method of claim 11, wherein
the second signal is an uplink signal and a transmitter of the second signal is a user equipment (UE) operating within a wireless communication system, and
the length of the measurement time interval is configured to comprise more than one downlink time interval and at least one uplink time interval.

15. (canceled)

16. The method of claim 11, wherein the second signal is a downlink signal and a transmitter of the second signal is a radio access node of a wireless communication system.

17. The method of claim 16, wherein the transmitter of the first signal is also the transmitter of the second signal, and wherein the first and second signals apply signaling beams of different width and/or different direction.

18. The method of claim 16, wherein the transmitter of the first signal is different from the transmitter of the second signal.

19. The method of claim 16, wherein the method is performed by a user equipment (UE) for evaluating radio access nodes during a connection process.

20. The method of claim 1, wherein
the method is performed by a test equipment for evaluating compliance with power regulations and/or for evaluating coverage provided by a radio reflector, and
the power regulations include power conditions for out-of-band frequencies, and the plurality of power samples is acquired for one or more out-of-band frequencies.

21. (canceled)

22. A computer program product comprising a non-transitory computer readable medium, having thereon a computer program comprising program instructions for configuring an apparatus to perform the method of claim 1.

23. An apparatus for determination of received power for a first signal without time synchronization relative a transmitter of the first signal, the apparatus comprising controlling circuitry configured to cause:
acquisition of a plurality of power samples received during a measurement time interval, wherein a length of the measurement time interval is configured to comprise at least some power samples of the first signal as well as at least some power samples without the first signal; and
determination of the received power for the first signal based on an estimated power level of the first signal, wherein the estimated power level of the first signal is distinguishable by statistical analysis of an occurrence of power values among the plurality of power samples.

24-46. (canceled)
